(19) United States
(12) Patent Application Publication
(10) Pub. No.: US 2025/0185031 A1
(43) Pub. Date: Jun. 5, 2025

(54) SIDELINK BEAM MAINTENANCE PROCEDURE

(71) Applicant: APPLE INC., Cupertino, CA (US)

(72) Inventors: Chunxuan Ye, San Diego, CA (US); Hong He, San Jose, CA (US); Dawei Zhang, Saratoga, CA (US); Haitong Sun, Cupertino, CA (US); Weidong Yang, San Diego, CA (US); Zhibin Wu, Los Altos, CA (US); Haijing Hu, Los Gatos, CA (US); Sigen Ye, San Diego, CA (US); Yushu Zhang, Beijing (CN); Wei Zeng, Saratoga, CA (US)

(21) Appl. No.: 18/842,922

(22) PCT Filed: Feb. 23, 2023
(86) PCT No.: PCT/US2023/063112

§ 371 Date: Aug. 30, 2024

Related U.S. Application Data
(60) Provisional application No. 63/268,883, filed on Mar. 4, 2022.

(51) Int. Cl. H04W 72/25; H04B 7/06; H04W 24/10

(52) U.S. Cl. CPC H04W 72/25; H04B 7/0626; H04B 7/06952; H04W 24/10

(57) ABSTRACT

Systems and methods for sidelink (SL) beam maintenance procedures between a transmit (Tx) user equipment (UE) and a receive (Rx) UE are disclosed herein. The Tx UE may send a combined physical sidelink control channel (PSCCH)/physical sidelink shared channel (PSSCH) having one or more channel state information reference signals (CSI-RSs) on corresponding beams to the Rx UE. The Rx UE may perform beam measurement on the CSI-RSs and send a beam report to the Tx UE that is based on such measurement. Systems and methods for triggering SL beam measurement between the Tx UE and the Rx UE, for performing various procedures for SL beam maintenance between the Tx UE and the Rx UE, and for sending beam reports between the Tx UE and the Rx UE are described.

### TECHNICAL FIELD

This application relates generally to wireless communication systems, including wireless communications systems that include a transmit (Tx) UE that communicates with a receive (Rx) UE using sidelink (SL) communications.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FRI) may include frequency bands operating in sub-6 GHz frequencies, some of which are bands that may be used by previous standards, and may potentially be extended to cover new spectrum offerings from 410 MHz to 7125 MHz. Frequency Range 2 (FR2) may include frequency bands from 24.25 GHz to 52.6 GHz. Note that in some systems, FR2 may also include frequency bands from 52.6 GHz to 71 GHz (or beyond). Bands in the millimeter wave (mmWave) range of FR2 may have smaller coverage but potentially higher available bandwidth than bands in FRI. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a method of sidelink channel state information reference signal acquisition between a transmit UE and a receive UE, according to an embodiment.

FIG. 2 illustrates an L1-SINR report format, according to an embodiment.

FIG. 3A illustrates a MAC CE of a beam report, according to an embodiment.

FIG. 3B illustrates a MAC CE of a beam report, according to an embodiment.

FIG. 4A illustrates a first option for beamforming for a pair of TBs each having different CSI-RSs, where each of the TBs is retransmitted, according to an embodiment.

FIG. 4B illustrates a second option for beamforming for a pair of TBs each having different CSI-RSs, where each of the TBs is retransmitted, according to an embodiment.

FIG. 5 illustrates a method of a first UE for performing SL communications with a second UE, according to an embodiment.

FIG. 6 illustrates a method of an Rx UE for performing SL communications with a Tx UE, according to an embodiment.

FIG. 7 illustrates a method of a Tx UE for performing SL communications with an Rx UE, according to an embodiment.

FIG. 8 illustrates a method of a Tx UE for performing SL communications with an Rx UE, according to an embodiment.

FIG. 9 illustrates a method of an Rx UE for performing SL communications with a Tx UE, according to an embodiment.

FIG. 10 illustrates a method of a Tx UE for performing SL communications with an Rx UE, according to an embodiment.

FIG. 11 illustrates a method of a Tx UE for performing SL communications with an Rx UE, according to an embodiment

FIG. 12 illustrates a method of an Rx UE for performing SL communications with a Tx UE, according to an embodiment.

FIG. 13 illustrates a method of an Rx UE for performing SL communications with a Tx UE, according to an embodiment.

FIG. 14 illustrates an example architecture of a wireless communication system, according to embodiments disclosed herein.

FIG. 15 illustrates a system for performing signaling between a first wireless device and a second wireless device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

### Embodiments of Sidelink (SL) CSI Acquisition

In embodiments herein, sidelink (SL) communications among two or more UE are discussed. The SL communications discussed herein contemplate communications that occur between the two or more UE without the use of an intermediary RAN device such as a base station. For example, the SL communications discussed herein include the case where signaling generated by a first UE is (directly) received at and used by a second UE.

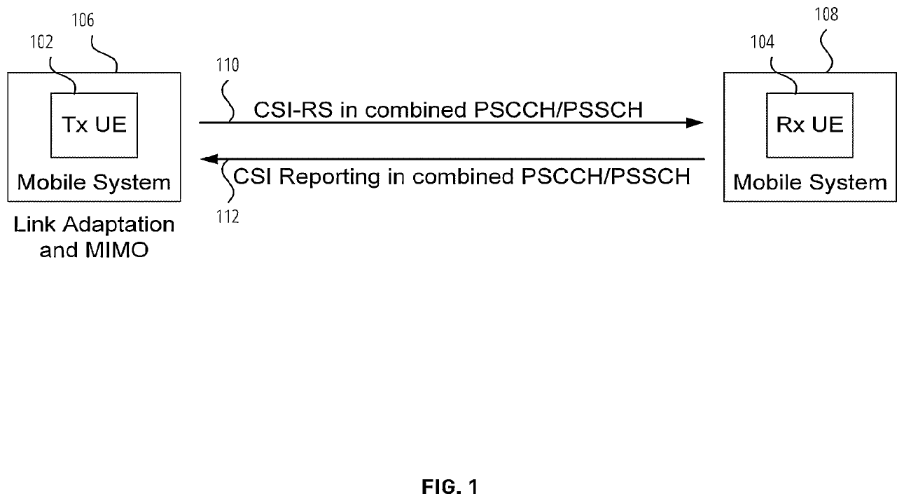

FIG. 1 illustrates a method of SL channel state information reference signal (CSI-RS) acquisition between a transmit (Tx) UE 102 and a receive (Rx) UE 104, according to an embodiment. As used herein, the term “Tx UE” may refer to a first UE that transmits a combined physical sidelink control channel (PSCCH)/physical sidelink shared channel (PSSCH) to an Rx UE. Accordingly, as used here, the term “Rx UE” may refer to a second UE that receives such a combined PSSCH/PSSCH.

In the embodiment of FIG. 1, the Tx UE 102 has been illustrated as part of the first mobile system 106 (e.g., a moving vehicle) and the Rx UE 104 has been illustrated as part of the second mobile system 108. This has been given by way of example and not by limitation. In other words, it is contemplated that one or both of the Tx UE 102 and the Rx UE 104 could be UE that are not in or on mobile system.

As illustrated in FIG. 1, a first SL transmission 110 may be sent from the Tx UE 102 to the Rx UE 104. This transmission may include a CSI-RS in a combined PSCCH/PSSCH. The first SL transmission 110 may be a unicast transmission between the Tx UE 102 and the Rx UE 104. The first SL transmission 110 may have been previously configured as between the Tx UE 102 and the Rx UE 104 using SL communication (e.g., PC5-Radio Resource Control (PC5-RRC) signaling having the configuration as sent from the Tx UE 102 to the Rx UE 104). The use of the CSI-RS may be enabled or disabled by this such configuration information.

The Rx UE 104 is capable of measuring the CSI-RS once the first SL transmission 110 is received. The Rx UE 104 is further capable of sending a second SL transmission 112 that contains CSI reporting in a (second) combined PSCCH/PSSCH, whereby information regarding the CSI-RS (corresponding to the measurement of the CSI-RS by the Rx UE 104) is sent by the Rx UE 104 back to the Tx UE 102. The Tx UE 102 may trigger this CSI reporting using sidelink control information (SCI) included in the combined PSCCH/PSSCH that contains the CSI-RS.

In such embodiments, the location of the CSI-RS in the time domain may be understood by the Rx UE 104 to be the slot where the CSI trigger is received from the Tx UE 102. The location of the CSI-RS in the frequency domain may be understood to be within the physical resource blocks (PRBs) that are scheduled for use by the combined PSCCH/PSSCH in that same slot.

In some embodiments, the described triggering behavior for the SCI reporting may be aperiodic in nature. The contents of the CSI reporting may include one or more of a rank indicator (RI) and a channel quality index (CQI), which may then be used by the Tx UE 102 for link adaptation and/or multiple input multiple output (MIMO) precoding relative to subsequent SL transmission(s) from the Tx UE 102 to the Rx UE 104 (as is illustrated in FIG. 1). The CQI value may be generated based on, for example, a modulation and coding scheme (MCS) table known at the Rx UE 104. The RI and/or CQI values may be reported in a medium access control control element (MAC CE) carried with the combined PSCCH/PSSCH of the second SL transmission 112.

It may be that the Tx UE 102 does not issue multiple CSI triggers within a single CSI report window of the unicast session between the Tx UE 102 and the Rx UE 104. A latency bound for a CSI report (e.g., that controls the CSI report window length relative to the CSI trigger) may be signaled from the Tx UE 102 to the Rx UE 104 (e.g., via PC5-RRC signaling) such that the Rx UE 104 can ensure that transmissions of CSI reports by the Rx UE 104 to the Tx UE 102 occur within the CSI report window.

### Embodiments of Uu Beam Management

In some embodiments, a base station may configure a list of synchronization signal blocks (SSBs) and/or CSI-RSs which a UE is to measure and report (e.g., by providing a measured Layer 1 (L1) reference signal received power (RSRP) (L1-RSRP) of the SSBs/CSI-RSs to the base station). As part of this process, different base station transmission beams may be applied to different ones of the SSBs/CSI-RSs.

These SSBs/CSI-RSs may be transmitted in a periodic manner, in a semi-persistent manner, or an aperiodic manner. Further, the report of the L1-RSRP values as made by the receiving UE may be transmitted by that UE in a periodic manner, in a semi-persistent manner, or an aperiodic manner. In some embodiments, the base station may configure up to 4 beams (as associated with their SSBs/CSI-RSs) for each instance of an uplink (UL) L1-RSRP report. In cases where more than one L1-RSRP is reported in an instance of the L1-RSRP report, differential L1-RSRP reporting may be used. In such cases, a first of the up to four L1-RSRP values (e.g., corresponding to CSI-RS resource indicator (CRI)/SSB resource indicator (SSBRI) #1 for the L1-RSRP report) is reported as an absolute value, and the remaining up to three L1-RSRP values are reported as differential values relative to that absolute value.

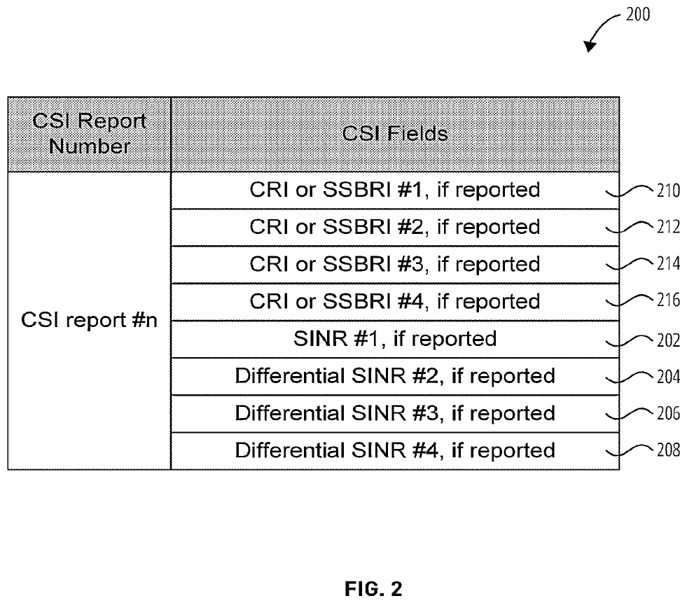

In some embodiments, the base station may configure the UE to report L1 signal to interference and noise ratio (SINR) (L1-SINR) value(s) in place of, or in addition to, the L1-RSRP values just described. FIG. 2 illustrates an L1-SINR report format 200, according to an embodiment. The L1-SINR report format 200 illustrates a use of differential L1-SINR reporting between the UE and the base station. The L1-SINR report format 200 comprises up to four SINR values 202, 204, 206, and 208, with up to four corresponding CRIs/SSBRIs 210, 212, 214, and 216.

In such cases, a first SINR value 202 (e.g., corresponding to the CRI/SSBRI #1 210) is reported as an absolute value, and the remaining up to three L1-RSRP values (the second SINR value 204, the third SINR value 206, and the fourth SINR value 208, corresponding respectively to the CRI/SSBRI #2 212, the CRI/SSBRI #3 214, and the CRI/SSBRI #4 216) are reported as differential values relative to that absolute value. The first SINR value 202 may be quantized such that it can be represented using seven bits, with a range of [−23, 40] decibels (dB) and a step size of 0.5 db. The second SINR value 204, the third SINR value 206, and the fourth SINR value 208 may each be quantized based on 4 bits, and may use a 1 db step size.

### Embodiments of SL Beam Reporting

Returning now to FIG. 1, embodiments disclosed herein discuss aspects of SL beam reporting between a Tx UE 102 and a Rx UE 104. Such embodiments may go beyond the reporting of RI/CQI as previously described in relation to FIG. 1, in that the first SL transmission 110 is configured to enable the Rx UE 104 to (also) report information that is particular to one or more of multiple Tx beams used by the Tx UE 102.

For example, in some embodiments, the Tx UE 102 may generate and send one or more CSI-RSs as part of the first SL transmission 110 (e.g., in a combined PSCCH/PSSCH). Each of these one or more CSI-RSs may be transmitted within the combined PSCCH/PSSCH on a corresponding one of one or more Tx beams of a beamforming used by the Tx UE 102 used to communicate with the Rx UE 104 (and note that such beams on which the one or more CSI-RSs are sent may be different than a Tx beam used by the Tx UE 102 to transmit the (rest of the) combined PSCCH/PSSCH itself). Once received at the Rx UE 104, the one or more CSI-RSs may be measured by the Rx UE 104. Examples of measurements that may be so taken include measuring an RSRP of the one or more CSI-RSs and/or measuring a SINR for the CSI-RSs, etc.

The first SL transmission 110 may include SCI that triggers beam measurement and beam reporting by the Rx UE 104 based on the CSI-RSs provided in the first SL transmission 110.

The second SL transmission 112 includes CSI reporting corresponding to the multiple CSI-RSs based on the measurements of the multiple CSI-RSs at the Rx UE 104. For example, measured L1-RSRP and/or L1-SINR values for one, some, or all of the multiple CSI-RSs may be included in this CSI reporting. Alternatively or additionally, an indication of one, some or all of a number X of the strongest CSI-RSs (e.g., CSI-RSs with the highest measured L1-RSRP and/or L1-SINR values) may be given.

Because of the correspondence between beams used to send the CSI-RSs and the CSI-RSs themselves, the Tx UE 102 is enabled (upon receiving the second SL transmission 112) to make conclusions regarding one or more of the beams. For example, if the second SL transmission 112 includes CSI reporting that indicates a given CSI-RS of the one or more CSI-RSs corresponds to a strongest/highest RSRP/SINR measured value, the Tx UE 102 can conclude accordingly that the beam used to send that given CSI-RS to the Rx UE 104 is a best beam to use for future transmissions to the Rx UE 104.

Herein, this CSI reporting that includes CSI-RS related information that can be related back to one or more individual beams by the Tx UE 102 in the manner described herein may be referred to as “beam reporting,” and an instance of such CSI reporting may accordingly be referred to herein as a “beam report.”

### Embodiments for Triggering SL Beam Measurement

Beam measurement (e.g., as has been described above) between a pair of UE may be triggered. A pair of UE may communicate using a beam pair that is currently configured for SL communication between the UEs. After any initial beam pairing, it may be desirable to measure one or more of the beams from time to time to ensure that they are still good beam for the SL communication. Such measurement(s) may occur responsive to a triggering mechanism. Various triggering mechanisms will now be described.

In some embodiments, a beam measurement is triggered periodically. The nature of the periodic triggering may be configured as between the UEs. The periodicity used for beam measurement may be based on a distance between the UE. For example, if the distance between the UEs is relatively larger, then a beam measurement periodicity may be relatively shorter (for relatively more frequent measurements), and if the distance between the UEs is relatively smaller, then the beam measurement periodicity may be relatively longer (for relatively less frequent measurements).

In such embodiments, the distance between the two UEs may be calculated based on location zone. For example, a first of the two UEs may receive a zone identifier (ID) from a second UE. The zone ID may identify the zone in which the second UE is currently found, as known to the second UE. The first UE may then determine a distance between the two UEs based on the zone information of the second UE and its own location. The first UE may then determine a periodicity for ongoing beam measurement between the UEs based on this distance. These beam measurements may be taken by the first UE using combined PSCCH/PSSCH transmissions from the second UE. Beam reporting from the first UE to the second UE may also be performed based on these measurements, in some embodiments.

In some embodiments, a beam measurement is triggered based on an event. In some of these cases, a Rx UE 104 can send a request to a Tx UE 102 that triggers the beam measurement in response to the detection of an event at the Rx UE 104. This event may be, for example, a pre-defined event, such as measured quality (e.g., an L1-RSRP or L1-SINR) for a current serving beam falling below a threshold, and/or hypothetical block error rate (BLER) on an current serving beam rising higher than a threshold value. A request from an Rx UE 104 to the Tx UE 102 may indicate that the Rx UE 104 wishes to perform one or both of beam measurement (e.g., for Rx UE beam refinement) and/or beam reporting (e.g., for Tx UE beam refinement).

Note that a “serving beam” of a combined PSCCH/PSSCH may in such cases be, for example, the beam that is used to transmit the SCI of the combined PSCCH/PSSCH, or the beam that is used to transmit the portions of the combined PSCCH/PSSCH that are not the CSI-RSs (note that these may be the same beam).

In others of these cases, a Tx UE 102 can detect an event and trigger beam measurement at the Rx UE 104 accordingly. For example, this may occur in cases where the Tx UE 102 receives a number of consecutive negative acknowledgements (NACKs) for its data transmissions (e.g., combined PSCCH/PSSCH transmissions) to the Rx UE 104.

In some embodiments, a beam measurement is triggered based on a timer. The Tx UE 102 may use one or more of a beam measurement timer and/or a beam report timer. A beam measurement timer may track an amount of time since a previous combined PSCCH/PSSCH transmission configured for beam measurement by the Rx UE 104 was sent to the Rx UE 104. A beam report timer may track an amount of time since a latest beam report was received at the Tx UE 102 from the Rx UE 104.

Upon expiration of one of a beam measurement timer or a beam report timer, the Tx UE 102 may send a combined PSCCH/PSSCH to the Rx UE 104 that is configured to be used for a beam measurement at the Rx UE 104. For example, the combined PSCCH/PSSCH may include one or more CSI-RSs on corresponding beams (as described above) to enable the Rx UE 104 to perform beam measurement. In some cases, the Rx UE may further perform beam reporting based on the beam measurement.

### Embodiments for SL Beam Maintenance Procedure

SL beam maintenance procedures that may be performed between a Tx UE 102 and an Rx UE 104 based on beam measurement will now be described. In such embodiments, it may be that the Tx UE 102 and the Rx UE 104 have been configured with a beam pair that is used for SL communications.

Rx UE behaviors related to beam maintenance procedures are now described. Optionally, an Rx UE 104 may trigger a beam measurement that is used for beam maintenance by sending a request to the Tx UE 102 for the Tx UE 102 to send a combined PSCCH/PSSCH having one or more CSI-RSs for beam measurement, as has been described herein. This request may be carried in a MAC CE, or in stage 2 of SCI (e.g., in a combined PSCCH/PSSCH from the Rx UE 104 to the Tx UE 102).

The request may be transmitted using resources selected using a SL resource selection procedure. The SL resource selection procedure so used may indicate a data priority for the request that is based on (e.g., configured or pre-configured according to) the resource pool being used for SL communications between the Rx UE 104 and the Tx UE 102. Alternatively, a specific beam maintenance configuration at the Rx UE 104 may be used to determine the data priority for the request.

In either event (whether triggered by the Rx UE 104 as described, or otherwise), the Rx UE 104 may receive a combined PSCCH/PSSCH from the Tx UE 102 that is to be used for beam maintenance. The Rx UE 104 proceeds perform beam measurement using this combined PSCCH/PSSCH by measuring one or more CSI-RSs of the combined PSCCH/PSSCH, as has been described. As part of this beam measurement, the measured quality (e.g., L1-RSRP and/or L1-SINR) of the serving beam may be determined. The Rx UE 104 may then compare the measured quality of the serving beam to a threshold in order to determine whether to trigger a beam pairing procedure between the Tx UE 102 and the Rx UE 104. This threshold may have been configured between the Tx UE 102 and the Rx UE 104.

If the measured quality of the serving beam is above (or at or above) the threshold, the Rx UE 104 may determine not to trigger the beam paring procedure. In some of these cases, the Rx UE 104 may send explicit feedback to the Tx UE 102 that indicates that the beam paring procedure is not triggered.

If the measured quality of the serving beam is below (or at or below) the threshold, the Rx UE 104 may determine to trigger the beam paring procedure. In such a case, the Rx UE 104 may send the Tx UE 102 an indication that the beam paring procedure is triggered. In some cases, this indication may include the measured quality of the serving beam (as was measured by the Rx UE 104). In other cases, this indication may simply comprise an indicator (other than the actual measured value) for the Tx UE 102 that the measured quality was below (or at or below) the threshold.

Tx UE behaviors for related to beam maintenance procedures are now described. The Tx UE 102 may send one or more combined PSCCH/PSSCHs having CSI-RSs for beam measurement to an Rx UE 104. The sending of the one or more combined PSCCH/PSSCHs may be performed in response to a trigger at the Tx UE 102. Examples of such triggers may include, but are not limited to, expiration of a configured timer for SL beam maintenance, reception of a request for the one or more combined PSCCH/PSSCHs from the Rx UE 104, and/or detection of a beam measurement event. Alternatively to any trigger-based methods, it may be that the combined PSCCH/PSSCHs are sent according to a configured beam measurement periodicity (e.g., for transmitting such combined PSCCH/PSSCHs). The some or all of the one or more combined PSCCH/PSSCHs may include dummy user plane (UP) data for the Rx UE 104, or may be used for actual UP data.

In some cases, the one or more combined PSCCH/PSSCHs are sent on resources selected using a SL resource selection procedure. In such cases, a packet delay budget (PDB) for the SL resource selection procedure may be based on a configured timer value. Further, in some cases a priority value for the one or more combined PSCCH/PSSCHs that is used during the SL resource selection procedure may be determined at the Tx UE 102 according to (e.g., configured or pre-configured according to) a resource pool used for the one or more combined PSCCH/PSSCH transmissions between the Tx UE 102 and the Rx UE 104 on SL. Alternatively, a priority value for the one or more combined PSCCH/PSSCH transmissions used during the SL resource selection procedure may be otherwise pre-defined at the Tx UE 102, or may be configured at the Tx UE 102 based on signaling (e.g., PC5-RRC signaling) between the Tx UE 102 and the Rx UE 104.

In some cases, the one or more combined PSCCH/PSSCHs are sent on dedicated resources (e.g., resources reserved for the use of these PSCCH/PSSCHs). In these instances, it may be that the dedicated resources are periodically reserved for the purpose of beam measurement. In other cases, the dedicated resources may correspond to sub-channels indicated by a resource pool configuration (or pre-configuration) for a resource pool used for the one or more combined PSCCH/PSSCH transmissions.

The Rx UE 104 may then perform beam measurement using the one or more combined PSCCH/PSSCHs.

In some embodiments, the Rx UE 104 may then proceed to send the Tx UE 102 one or more beam reports in response. These beam reports may indicate actual measured quality values (e.g., L1-RSRP, L1-SINR) for the one or more beams represented in the one or more combined PSCCH/PSSCHs.

In some of these cases, the Tx UE 102 may track the number of times that a measured quality of the serving beam is reported to be below (or at or below) a threshold value. The Tx UE 102 may proceed to trigger a beam pairing procedure when the measured quality of the serving beam from a minimum number of one or more beam reports is below the threshold (e.g., up to a counter amount of times). In some instances, this behavior is tracked as to consecutive beam reports, and the counter number of times is reset when a beam report indicates that the measured quality of the serving beam is at (or at or above) the threshold value.

In some embodiments, an acknowledgement status for a combined PSCCH/PSSCH may be used for determining whether to trigger a beam pairing procedure. For example, it may be that the SL communications between the Tx UE 102 and the Rx UE 104 call for acknowledgement (ACK)/NACK feedback from the Rx UE 104 to the Tx UE 102 corresponding to the combined PSCCH/PSSCH sent by the Tx UE 102 to the Rx UE 104. Accordingly, an acknowledgment status may include an ACK, a NACK, and or a failure to receive expected acknowledgement signaling.

In a first case, if the acknowledgement status is that NACK is received at the Tx UE 102 corresponding to the combined PSCCH/PSSCH, the Tx UE 102 may proceed to trigger the beam pairing procedure. If the acknowledgement status is that an ACK is received at the Tx UE 102, or that expected acknowledgement signaling is not received at the Tx UE 102, the Tx UE 102 may not trigger the beam paring procedure (e.g., the current beam pair is kept).

In a second case, if the acknowledgement status is that NACK is received at the Tx UE 102 corresponding to the combined PSCCH/PSSCH, or that expected acknowledgement signaling is not received at the Tx UE 102, the Tx UE 102 may proceed to trigger the beam pairing procedure. If the acknowledgement status is that an ACK is received at the Tx UE 102, the Tx UE may not trigger the beam paring procedure (e.g., the current beam pair is kept).

### Embodiments for SL Beam Reporting Contents

Various embodiments for SL beam report contents will now be described. As has been described, a Tx UE 102 may receive, from an Rx UE 104, one or more combined PSCCH/PSSCHs each having one or more CSI-RSs, and one or more beam measurements may be performed using the CSI-RSs. A beam report for one or more results of the one or more beam measurements is then sent to the Tx UE 102. As will be described, in some embodiments, beam reports may be understood in relation to a beam ID for a reported-on beam.

In some embodiments, a UE may use joint beam reporting that allows the UE to report one or more measured quality values for corresponding one or more beams. The one or more measured quality values of a beam report may include an absolute quality value of a first beam of the beam report. The one or more measured quality values of the beam report may, in some embodiments, further include one or more differential quality values for additional beam(s) of the beam report.

In some cases, joint beam reporting may use the beam ID for the reported-on beams implicitly. For example, the beam ID(s) of the beam(s) corresponding to the measured quality value(s) in the beam report may not be explicitly provided in the beam report: rather, the one or more measured qualities may be ordered in the beam report such that the ordering implicitly relates the beam IDs corresponding to those values.

Joint beam reporting as described may be provided from the Rx UE 104 to the Tx UE 102 using a MAC CE and/or SCI of a combined PSCCH/PSSCH sent from the Rx UE 104 to the Tx UE 102.

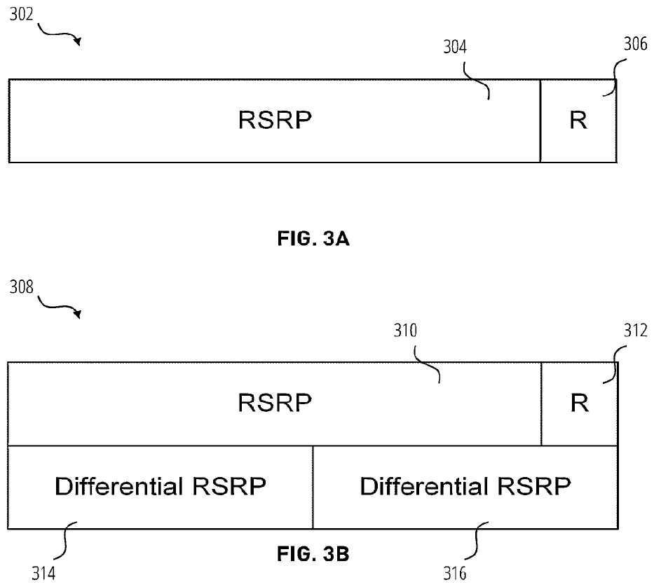

FIG. 3A illustrates a MAC CE 302 of a beam report, according to an embodiment. The MAC CE 302 includes an absolute L1-RSRP field 304 and a reserved bit 306. In the illustrated embodiment of FIG. 3A, the absolute L1-RSRP field 304 may use up to seven bits, and so a measured RSRP quality value of a first (e.g., strongest) beam may be quantized by the Rx UE 104 such that it is represented using seven bits and then placed in the absolute L1-RSRP field 304.

FIG. 3B illustrates a MAC CE 308 of a beam report, according to an embodiment. The MAC CE 308 includes an absolute L1-RSRP field 310, a reserved bit 312, a first differential L1-RSRP field 314, and a second differential L1-RSRP field 316. In the illustrated embodiment of FIG. 3B, the absolute L1-RSRP field 310 may use up to seven bits, and so a measured L1-RSRP quality value of a first (e.g., strongest) beam may be quantized by the Rx UE 104 such that it is represented using seven bits and then placed in the absolute L1-RSRP field 304. The Rx UE 104 may also calculate one or more differential RSRP values corresponding to measured L1-RSRP quality values of one or more additional beams (e.g., in the form of values denoting a magnitude difference from the measured L1-RSRP quality value of the first beam). In the illustrated embodiment, each of the first differential L1-RSRP field 314 and the second differential L1-RSRP field 316 may use up to four bits. Accordingly, the calculated differential RSRP quality values may be quantized by the Rx UE 104 such that they are represented using four bits, and the placed in the first differential L1-RSRP field 314 and the second differential L1-RSRP field 316.

While FIG. 3A and FIG. 3B have been illustrated in terms of L1-RSRP use, it is contemplated that other measured quality types (e.g., L1-SINR) could instead be analogously used.

In some embodiments, a UE may instead use separate beam reporting. In such cases, the UE reports one measured quality value for one corresponding beam in the beam report.

In some cases, joint beam reporting may use the beam ID for the reported-on beams implicitly. For example, the beam ID of the beam corresponding to the measured quality value in the beam report may not be explicitly provided in the beam report; rather, the beam report may be sent in a resource that is known to correspond to the beam ID. In other instances, the beam ID of the beam may be explicitly reported. Separate beam reporting as described may be provided from the Rx UE 104 to the Tx UE 102 using a MAC CE. SCI of a combined PSCCH/PSSCH sent from the Rx UE 104 to the Tx UE 102, or a physical sidelink feedback channel (PSFCH).

The MAC CE 302 of FIG. 3A (as has been described above) may be used for a beam report according to separate beam reporting.

In some embodiments, a beam report by an Rx UE 104 may report one or more beam IDs back to the Tx UE 102 (e.g., rather than reporting one or more measured quality values). In some cases, such a beam report may include the beam ID for a beam (or for one or more beams) that had the highest (or the one or more highest) measured quality values from among measured beams. In such cases, the number of the beam IDs provided in the beam report may be according to a configuration or pre-configuration of the Rx UE 104.

Alternatively, such a beam report may instead include beam IDs for all (e.g., one or more) beams that were measured at a measured quality value that is above (or at or above) a threshold value.

Beam reporting using beam IDs as described may be provided from the Rx UE 104 to the Tx UE 102 using a MAC CE. SCI of a combined PSCCH/PSSCH sent from the Rx UE 104 to the Tx UE 102, or a PSFCH.

In some cases, it may be that a combined PSCCH/PSSCH having a CSI-RS being measured is retransmitted. Accordingly, the CSI-RS being measured is sent more than once. In such cases, it may be that a beamforming configuration for retransmitted transport blocks (TBs) having the retransmitted CSI-RSs may be configured at each of the Tx UE 102 and the Rx UE 104, such that each remains aware of the relevant beam ID for the particular CSI-RS being measured for/reported in the beam report as to these combined PSCCH/PSSCH repetitions.

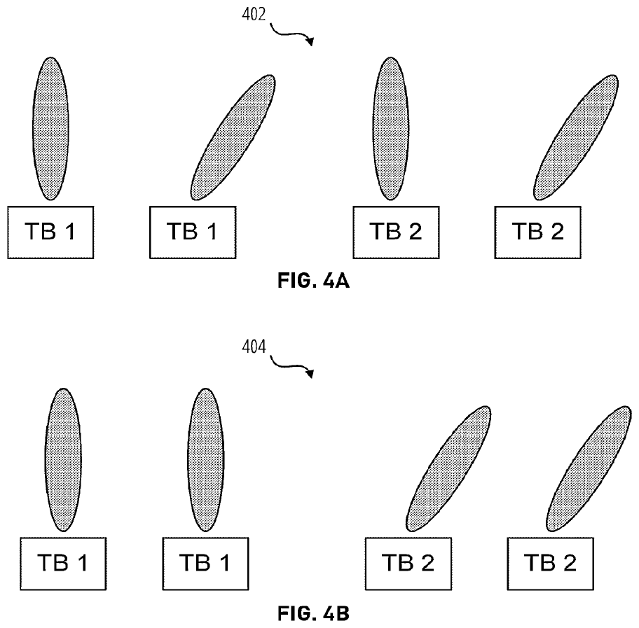

FIG. 4A illustrates a first option 402 for beamforming for a pair of TBs each having different CSI-RSs, where each of the TBs is retransmitted, according to an embodiment. In the first option 402, each of the two illustrates retransmissions for each of TB1 and TB2 is associated with a different beam, as illustrated. This may occur according to the configuration for such TB retransmissions such that the Rx UE 104 is aware of the change in beams.

FIG. 4B illustrates a second option 404 for beamforming for a pair of TBs each having different CSI-RSs, where each of the TBs is retransmitted, according to an embodiment. In the second option 404, each of the two illustrated retransmissions for each of TB1 and TB2 is associated with the same beam, as illustrated. This may occur according to the configuration for such TB retransmissions such that the Rx UE 104 is aware of the re-use of the same beam.

Beamforming configurations for TB retransmissions may be pre-configured or configured to the Tx UE 102 and the Rx UE 104 based on a resource pool used for SL communications between the Tx UE 102 and the Rx UE 104. Alternatively, beamforming configurations for TB retransmissions may be configured as between the Tx UE 102 and the Rx UE 104 using stage 2 of SCI on combined PSCCH/PSSCH transmitted between the Tx UE 102 and the Rx UE 104.

### EXAMPLE EMBODIMENTS

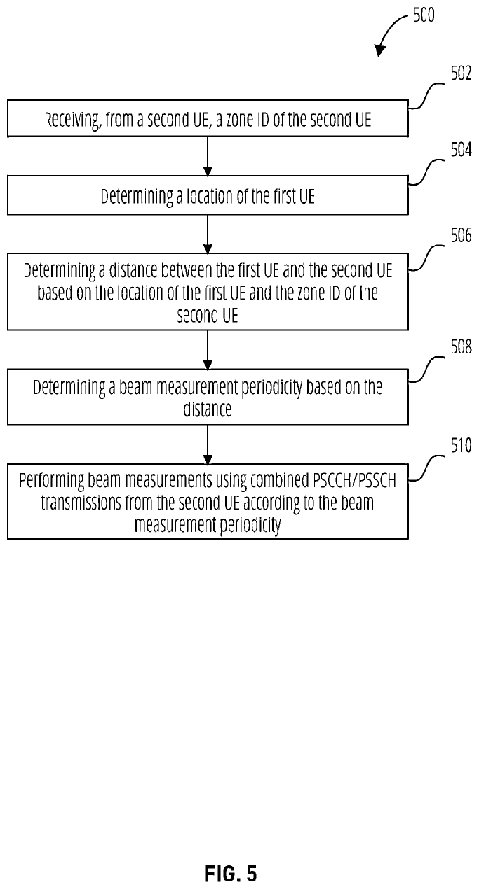

FIG. 5 illustrates a method 500 of a first UE for performing SL communications with a second UE, according to an embodiment. The method 500 includes receiving 502, from the second UE, a zone ID of the second UE.

The method 500 further includes determining 504 a location of the first UE.

The method 500 further includes determining 506 a distance between the first UE and the second UE based on the location of the first UE and the zone ID of the second UE.

The method 500 further includes determining 508 a beam measurement periodicity based on the distance.

The method 500 further includes performing 510 beam measurements using combined PSCCH/PSSCH transmissions from the second UE according to the beam measurement periodicity.

In some embodiments, the method 500 further comprises transmitting beam reports corresponding to the beam measurements to the second UE.

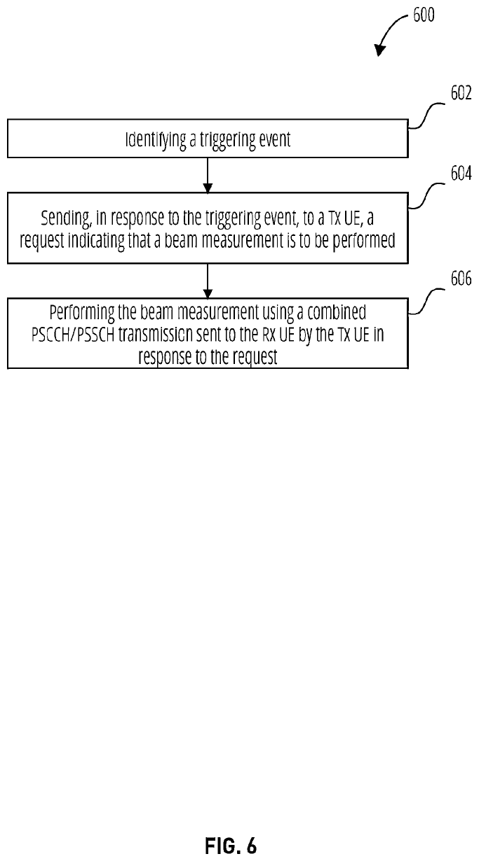

FIG. 6 illustrates a method 600 of an Rx UE for performing SL communications with a Tx UE, according to an embodiment. The method 600 includes identifying 602 a triggering event.

The method 600 further includes sending 604, in response to the triggering event, to the Tx UE, a request indicating that a beam measurement is to be performed.

The method 600 further includes performing 606 the beam measurement using a combined PSCCH/PSSCH transmission sent to the Rx UE by the Tx UE in response to the request.

In some embodiments of the method 600, the triggering event is that a measured quality of a serving beam is outside of a threshold.

In some embodiments of the method 600, the request further indicates that a beam report corresponding to the beam measurement is to be transmitted; and the method 600 further comprises sending, to the Tx UE, the beam report.

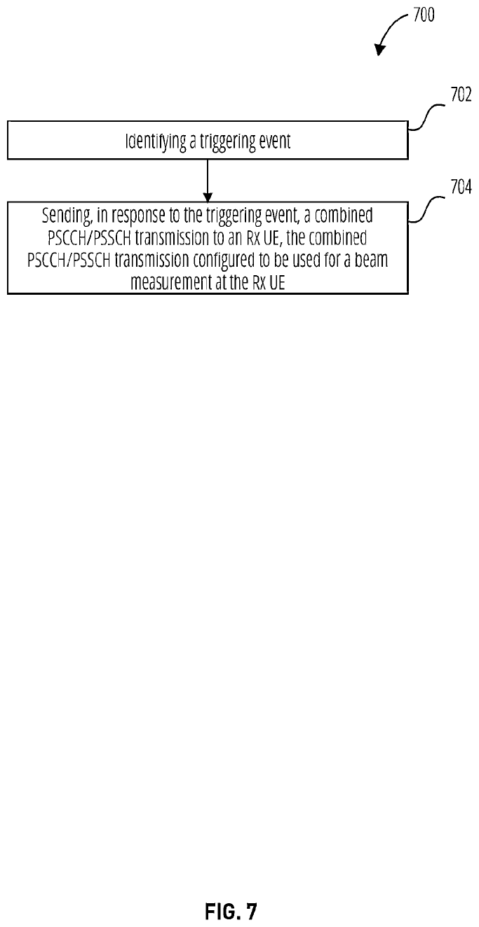

FIG. 7 illustrates a method 700 of a Tx UE for performing SL communications with an Rx UE, according to an embodiment. The method 700 includes identifying 702 identifying a triggering event.

The method 700 further includes sending 704, in response to the triggering event, a combined PSCCH/PSSCH transmission to the Rx UE, the combined PSCCH/PSSCH transmission configured to be used for a beam measurement at the Rx UE.

In some embodiments of the method 700, the triggering event is that the Tx UE receives a number of consecutive NACK messages from the Rx UE in response to combined PSCCH/PSSCH transmissions from the Tx UE to the Rx UE.

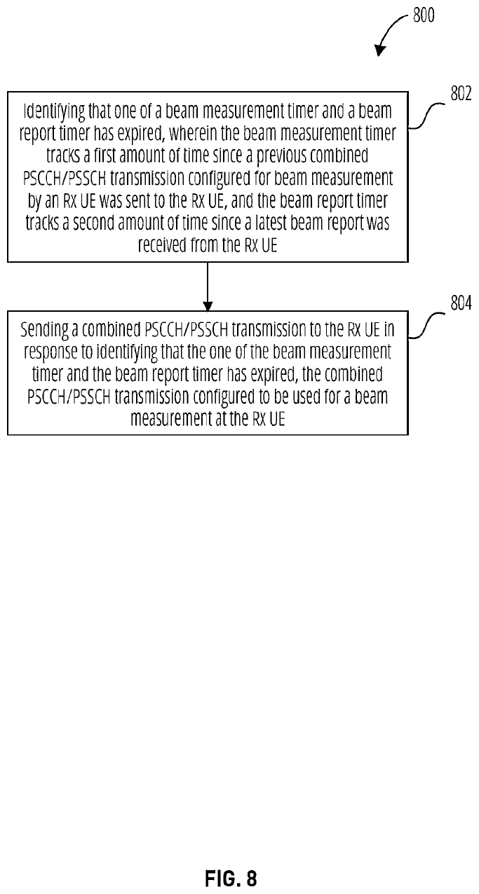

FIG. 8 illustrates a method 800 of a Tx UE for performing SL communications with an Rx UE, according to an embodiment. The method 800 includes identifying 802 that one of a beam measurement timer and a beam report timer has expired, wherein the beam measurement timer tracks a first amount of time since a previous combined PSCCH/PSSCH transmission configured for beam measurement by the Rx UE was sent to the Rx UE, and the beam report timer tracks a second amount of time since a latest beam report was received from the Rx UE.

The method 800 further includes sending 804 sending a combined PSCCH/PSSCH transmission to the Rx UE in response to identifying that the one of the beam measurement timer and the beam report timer has expired, the combined PSCCH/PSSCH transmission configured to be used for a beam measurement at the Rx UE.

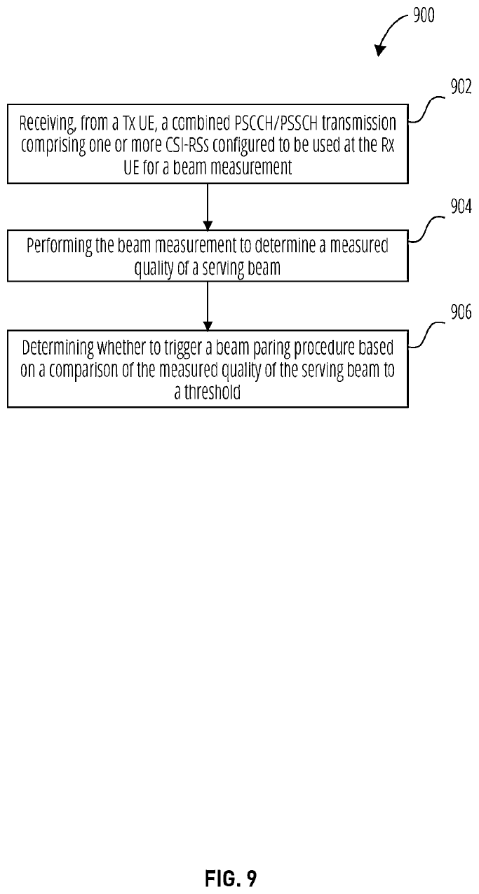

FIG. 9 illustrates a method 900 of an Rx UE for performing SL communications with a Tx UE, according to an embodiment. The method 900 includes receiving 902, from the Tx UE, a combined PSCCH/PSSCH transmission comprising one or more CSI-RSs configured to be used at the Rx UE for a beam measurement.

The method 900 further includes performing 904 the beam measurement to determine a measured quality of a serving beam.

The method 900 further includes determining 906 whether to trigger a beam paring procedure based on a comparison of the measured quality of the serving beam to a threshold.

In some embodiments of the method 900, the Rx UE determines not to trigger the beam paring procedure when the measured quality of the serving beam is above the threshold, and the method 900 further includes sending, to the Tx UE, an indication that the beam paring procedure is not triggered.

In some embodiments of the method 900, the Rx UE determines to trigger the beam paring procedure when the measured quality of the serving beam is below the threshold, and the method 900 further includes sending, to the Tx UE, an indication that the beam paring procedure is triggered. In some of these embodiments, the indication comprises the measured quality of the serving beam. In some of these embodiments, the indication comprises an indicator that the measured quality of the serving beam is below the threshold.

In some embodiments, the method 900 further includes sending, to the Tx UE, a request for the combined PSCCH/PSSCH transmission comprising the one or more CSI-RSs. In some of these embodiments, the request is sent in one of a MAC CE and stage 2 of SCI. In some of these embodiments, the request is carried out using a SL resource selection procedure according to a data priority that is one of: based on a resource pool for the SL communications, and based on a SL beam maintenance configuration at the Rx UE.

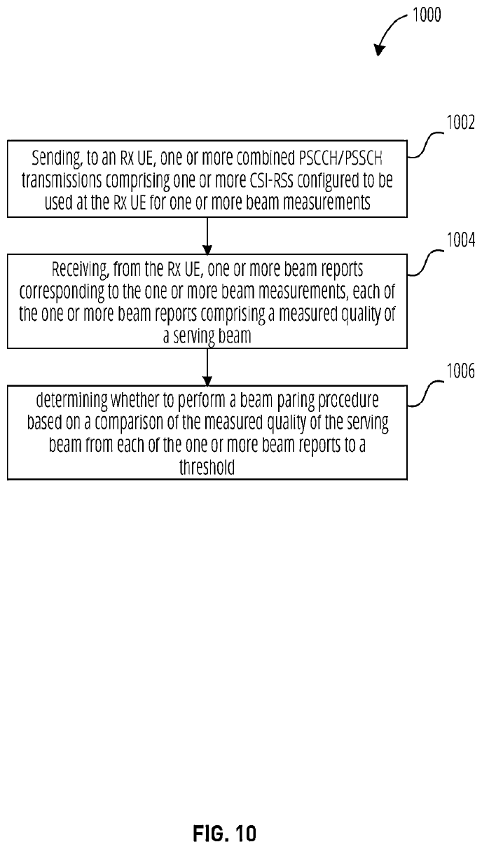

FIG. 10 illustrates a method 1000 of a Tx UE for performing SL communications with an Rx UE, according to an embodiment. The method 1000 includes sending 1002, to the Rx UE, one or more combined PSCCH/PSSCH transmissions comprising one or more CSI-RSs configured to be used at the Rx UE for one or more beam measurements.

The method 1000 further includes receiving 1004, from the Rx UE, one or more beam reports corresponding to the one or more beam measurements, each of the one or more beam reports comprising a measured quality of a serving beam.

The method 1000 further includes determining 1006 whether to perform a beam paring procedure based on a comparison of the measured quality of the serving beam from each of the one or more beam reports to a threshold.

In some embodiments of the method 1000, the beam paring procedure is performed when the measured quality of the serving beam from a minimum number of the one or more beam reports is below the threshold.

In some embodiments of the method 1000, the beam paring procedure is performed with the measured quality of the serving beam from a minimum number of consecutive beam reports of the one or more beam reports is below the threshold.

In some embodiments of the method 1000, the one or more combined PSCCH/PSSCH transmissions are sent in response to an expiration of a SL beam maintenance timer.

In some embodiments of the method 1000, the one or more combined PSCCH/PSSCH transmissions are sent according to a beam measurement periodicity configured at the Tx UE.

In some embodiments of the method 1000, the one or more combined PSCCH/PSSCH transmissions are sent in response to a request received from the Rx UE.

In some embodiments, the method 1000 further includes detecting a beam measurement event at the Tx UE, and the one or more combined PSCCH/PSSCH transmissions are sent in response to detecting the beam measurement event.

In some embodiments of the method 1000, the one or more combined PSCCH/PSSCH transmissions are sent on resources selected using a SL resource selection procedure. In some of these embodiments, a PDB for the SL resource selection procedure is based on a configured timer value. IN some of these embodiments, a priority value for the one or more combined PSCCH/PSSCH transmissions used during the SL resource selection procedure is determined at the Tx UE according to a resource pool used for the one or more combined PSCCH/PSSCH transmissions. In some of these embodiments, a priority value for the one or more combined PSCCH/PSSCH transmissions used during the SL resource selection procedure is pre-defined at the Tx UE. In some of these embodiments, a priority value for the one or more combined PSCCH/PSSCH transmissions used during the SL resource selection procedure is configured by signaling between the Tx UE and the Rx UE.

In some embodiments of the method 1000, the one or more combined PSCCH/PSSCH transmissions are sent using dedicated resources. In some of these embodiments, the dedicated resources are periodically reserved. In some of these embodiments, the dedicated resources correspond to sub-channels indicated by a resource pool configuration for a resource pool used for the one or more combined PSCCH/PSSCH transmissions.

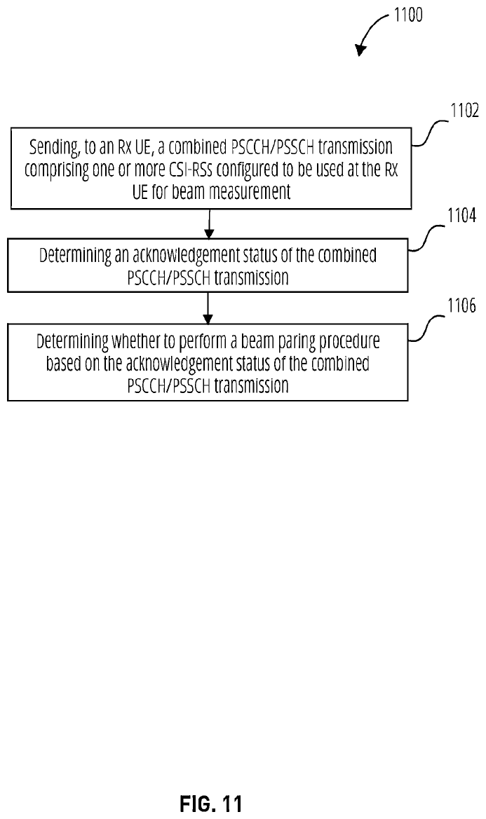

FIG. 11 illustrates a method 1100 of a Tx UE for performing SL communications with an Rx UE, according to an embodiment. The method 1100 includes sending 1102, to the Rx UE, a combined PSCCH/PSSCH transmission comprising one or more CSI-RSs configured to be used at the Rx UE for beam measurement.

The method 1100 further includes determining 1104 an acknowledgement status of the combined PSCCH/PSSCH transmission.

The method 1100 further includes determining 1106 whether to perform a beam paring procedure based on the acknowledgement status of the combined PSCCH/PSSCH transmission.

In some embodiments of the method 1100, the acknowledgment status comprises receiving an ACK from the Rx UE in response to the combined PSCCH/PSSCH transmission, and the Tx UE determines not to perform the beam paring procedure based on the ACK.

In some embodiments of the method 1100, the acknowledgment status comprises receiving a NACK from the Rx UE in response to the combined PSCCH/PSSCH transmission, and the Tx UE determines to perform the beam paring procedure based on the NACK.

In some embodiments of the method 1100, the acknowledgment status indicates a failure to receive acknowledgement signaling from the Rx UE in response to the combined PSCCH/PSSCH transmission, and the Tx UE determines to perform the beam paring procedure based on the failure to receive acknowledgement signaling

In some embodiments of the method 1100, the acknowledgment status indicates a failure to receive acknowledgement signaling from the Rx UE in response to the combined PSCCH/PSSCH transmission, and the Tx UE determines to not perform the beam paring procedure based on the failure to receive acknowledgement signaling.

In some embodiments of the method 1100, the combined PSCCH/PSSCH transmission is sent in response to an expiration of a SL beam maintenance timer.

In some embodiments of the method 1100, the combined PSCCH/PSSCH transmission is sent according to a beam measurement periodicity configured at the Tx UE.

In some embodiments of the method 1100, the combined PSCCH/PSSCH transmission is sent in response to a request received from the Rx UE.

In some embodiments, the method 1100 further includes detecting a beam measurement event at the Tx UE, and wherein the combined PSCCH/PSSCH transmission is sent in response to detecting the beam measurement event.

In some embodiments of the method 1100, the combined PSCCH/PSSCH transmission is sent on resources selected using a SL resource selection procedure. In some of these embodiments, a PDB for the SL resource selection procedure is based on a configured timer value. In some of these embodiments, a priority value for the combined PSCCH/PSSCH transmission used during the SL resource selection procedure is determined at the Tx UE according to a resource pool used for the combined PSCCH/PSSCH transmission. In some of these embodiments, a priority value for the combined PSCCH/PSSCH transmission used during the SL resource selection procedure is pre-defined at the Tx UE. In some of these embodiments, a priority value for the combined PSCCH/PSSCH transmission used during the SL resource selection procedure is configured by signaling between the Tx UE and the Rx UE.

In some embodiments of the method 1100, the combined PSCCH/PSSCH transmission is sent using dedicated resources. In some of these embodiments, the dedicated resources are periodically reserved. In some of these embodiments, the dedicated resources correspond to sub-channels indicated by a resource pool configuration for a resource pool used for the combined PSCCH/PSSCH transmission.

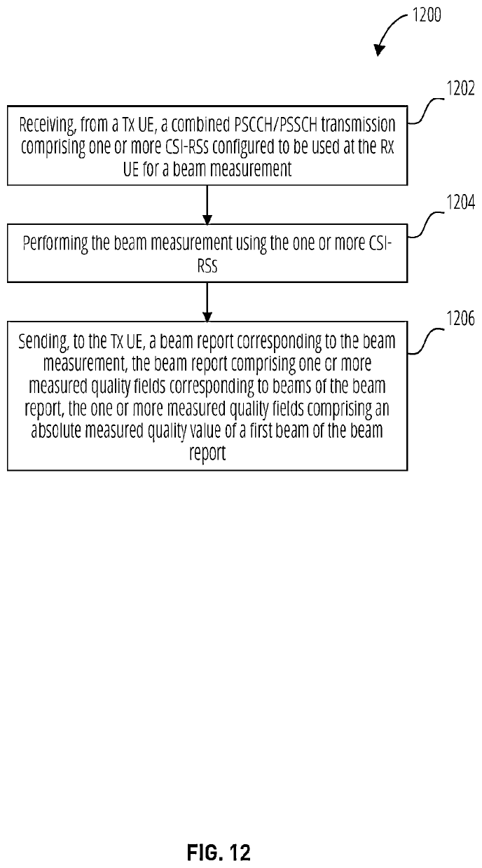

FIG. 12 illustrates a method 1200 of an Rx UE for performing SL communications with a Tx UE, according to an embodiment. The method 1200 includes receiving 1202, from the Tx UE, a combined PSCCH/PSSCH transmission comprising one or more CSI-RSs configured to be used at the Rx UE for a beam measurement.

The method 1200 further includes performing 1204 performing the beam measurement using the one or more CSI-RSs.

The method 1200 further includes sending 1206, to the Tx UE, a beam report corresponding to the beam measurement, the beam report comprising one or more measured quality fields corresponding to beams of the beam report, the one or more measured quality fields comprising an absolute measured quality value of a first beam of the beam report.

In some embodiments of the method 1200, the one or more measured quality fields further comprise a differential measured quality value of a second beam of the beam report, wherein the differential measured quality value is differential to the absolute measured quality value of the first beam.

In some embodiments of the method 1200, the beam report is sent in a MAC CE.

In some embodiments of the method 1200, the beam report is sent in SCI.

In some embodiments of the method 1200, the one or more measured quality fields are ordered in the beam report according to beam IDs of one or more corresponding beams. In some of these embodiments, a correspondence between the beam IDs and the one or more corresponding beams is determined according to a beam configuration for one or more TB retransmissions having the one or more CSI-RSs.

In some embodiments of the method 1200, the beam measurement measures a single beam, and wherein the beam report comprises a single measured quality field corresponding to the measurement of the single beam. In some of these embodiments, the beam report further comprises an ID for the single beam. In some of these embodiments, the beam report is sent to the Tx UE in a MAC CE. IN some of these embodiments, the beam report is sent to the Tx UE in SCI. In some of these embodiments, the beam report is sent to the Tx UE in a PSFCH.

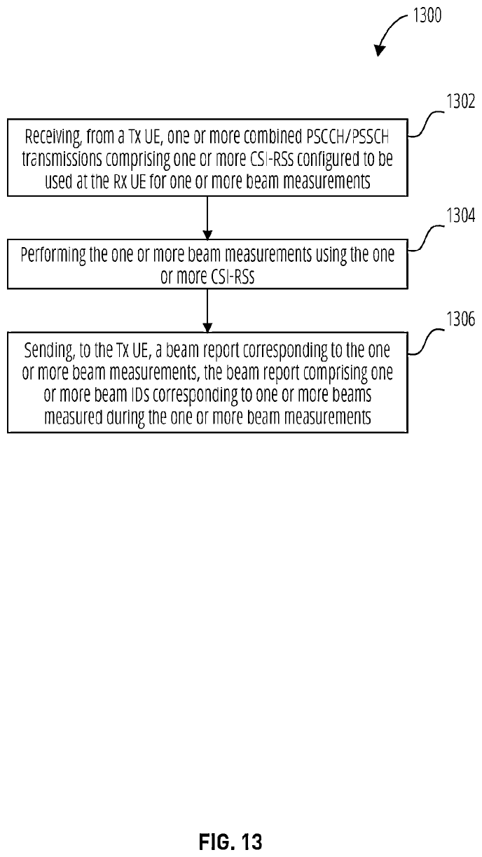

FIG. 13 illustrates a method 1300 of an Rx UE for performing SL communications with a Tx UE, according to an embodiment. The method 1300 includes receiving 1302, from the Tx UE, one or more combined PSCCH/PSSCH transmissions comprising one or more CSI-RSs configured to be used at the Rx UE for one or more beam measurements.

The method 1300 further includes performing 1304 the one or more beam measurements using the one or more CSI-RSs.

The method 1300 further includes sending 1306, to the Tx UE, a beam report corresponding to the one or more beam measurements, the beam report comprising one or more beam IDs corresponding to one or more beams measured during the one or more beam measurements.

In some embodiments of the method 1300, the one or more beams of the one or more beam IDs were measured to have a measured quality value above a threshold during the one or more beam measurements.

In some embodiments of the method 1300, the one or more beam IDs comprise a single beam ID corresponding to a single beam, and wherein the single beam was measured to have a highest measured quality value among the one or more beams during the one or more beam measurements.

In some embodiments of the method 1300, the beam report is sent to the Tx UE in a MAC CE.

In some embodiments of the method 1300, the beam report is sent to the Tx UE in SCI.

In some embodiments of the method 1300, the beam report is sent to the Tx UE in a PSFCH.

In some embodiments of the method 1300, a correspondence between the one or more beam IDs and the one or more beams is determined according to a beam configuration for one or more TB retransmissions having the one or more CSI-RSs.

Embodiments contemplated herein include an apparatus comprising means to perform one or more elements of the method 500, the method 600, the method 700, the method 800, the method 900, the method 1000, the method 1100, the method 1200, and/or the method 1300. This apparatus may be, for example, an apparatus of a UE (such as one of the first wireless device 1502 or the second wireless device 1518 that is a UE, as described herein).

Embodiments contemplated herein include one or more non-transitory computer-readable media comprising instructions to cause an electronic device, upon execution of the instructions by one or more processors of the electronic device, to perform one or more elements of the method 500, the method 600, the method 700, the method 800, the method 900, the method 1000, the method 1100, the method 1200, and/or the method 1300. This non-transitory computer-readable media may be, for example, a memory of a UE (such as a memory 1506 or memory 1522 of one of the first wireless device 1502 or the second wireless device 1518 that is a UE, as described herein).

Embodiments contemplated herein include an apparatus comprising logic, modules, or circuitry to perform one or more elements of the method 500, the method 600, the method 700, the method 800, the method 900, the method 1000, the method 1100, the method 1200, and/or the method 1300. This apparatus may be, for example, an apparatus of a UE (such as one of the first wireless device 1502 or the second wireless device 1518 that is a UE, as described herein).

Embodiments contemplated herein include an apparatus comprising: one or more processors and one or more computer-readable media comprising instructions that, when executed by the one or more processors, cause the one or more processors to perform one or more elements of the method 500, the method 600, the method 700, the method 800, the method 900, the method 1000, the method 1100, the method 1200, and/or the method 1300. This apparatus may be, for example, an apparatus of a UE (such as one of the first wireless device 1502 or the second wireless device 1518 that is a UE, as described herein).

Embodiments contemplated herein include a signal as described in or related to one or more elements of the method 500, the method 600, the method 700, the method 800, the method 900, the method 1000, the method 1100, the method 1200, and/or the method 1300.

Embodiments contemplated herein include a computer program or computer program product comprising instructions, wherein execution of the program by a processor is to cause the processor to carry out one or more elements of the method 500, the method 600, the method 700, the method 800, the method 900, the method 1000, the method 1100, the method 1200, and/or the method 1300. The processor may be a processor of a UE (such as processor(s) 1504 or processor(s) 1520 of one of the first wireless device 1502 or the second wireless device 1518 that is a UE, as described herein). These instructions may be, for example, located in the processor and/or on a memory of the UE (such as a memory 1506 or memory 1522 of one of the first wireless device 1502 or the second wireless device 1518 that is a UE, as described herein).

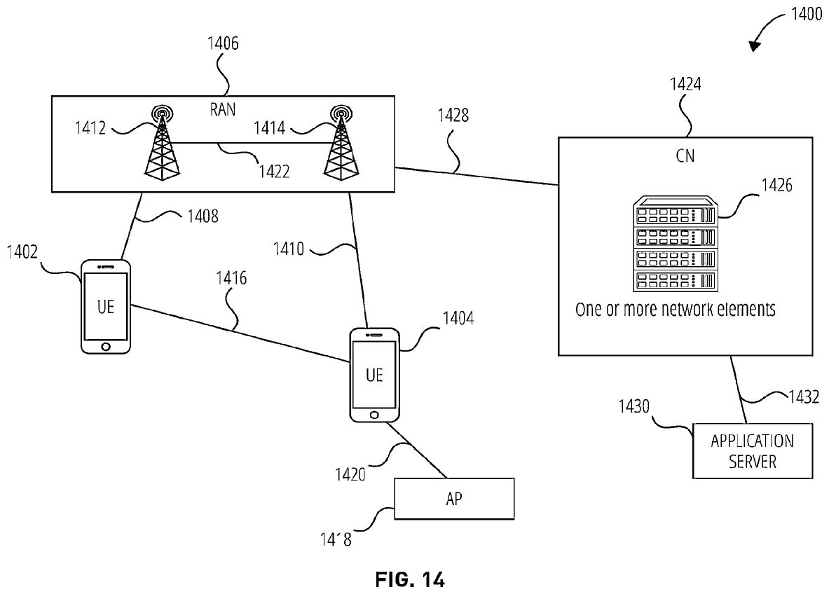

FIG. 14 illustrates an example architecture of a wireless communication system 1400, according to embodiments disclosed herein. The following description is provided for an example wireless communication system 1400 that operates in conjunction with the LTE system standards and/or 5G or NR system standards as provided by 3GPP technical specifications.

As shown by FIG. 14, the wireless communication system 1400 includes UE 1402 and UE 1404 (although any number of UEs may be used). In this example, the UE 1402 and the UE 1404 are illustrated as smartphones (e.g., handheld touchscreen mobile computing devices connectable to one or more cellular networks), but may also comprise any mobile or non-mobile computing device configured for wireless communication.

The UE 1402 and UE 1404 may be configured to communicatively couple with a RAN 1406. In embodiments, the RAN 1406 may be NG-RAN, E-UTRAN, etc. The UE 1402 and UE 1404 utilize connections (or channels) (shown as connection 1408 and connection 1410, respectively) with the RAN 1406, each of which comprises a physical communications interface. The RAN 1406 can include one or more base stations, such as base station 1412 and base station 1414, that enable the connection 1408 and connection 1410.

In this example, the connection 1408 and connection 1410 are air interfaces to enable such communicative coupling, and may be consistent with RAT(s) used by the RAN 1406, such as, for example, an LTE and/or NR.

In some embodiments, the UE 1402 and UE 1404 may also directly exchange communication data via a sidelink interface 1416. The UE 1404 is shown to be configured to access an access point (shown as AP 1418) via connection 1420. By way of example, the connection 1420 can comprise a local wireless connection, such as a connection consistent with any IEEE 802.11 protocol, wherein the AP 1418 may comprise a Wi-Fi® router. In this example, the AP 1418 may be connected to another network (for example, the Internet) without going through a CN 1424.

In embodiments, the UE 1402 and UE 1404 can be configured to communicate using orthogonal frequency division multiplexing (OFDM) communication signals with each other or with the base station 1412 and/or the base station 1414 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1412 or base station 1414 may be implemented as one or more software entities running on server computers as part of a virtual network. In addition, or in other embodiments, the base station 1412 or base station 1414 may be configured to communicate with one another via interface 1422. In embodiments where the wireless communication system 1400 is an LTE system (e.g., when the CN 1424 is an EPC), the interface 1422 may be an X2 interface. The X2 interface may be defined between two or more base stations (e.g., two or more eNBs and the like) that connect to an EPC, and/or between two eNBs connecting to the EPC. In embodiments where the wireless communication system 1400 is an NR system (e.g., when CN 1424 is a 5GC), the interface 1422 may be an Xn interface. The Xn interface is defined between two or more base stations (e.g., two or more gNBs and the like) that connect to 5GC, between a base station 1412 (e.g., a gNB) connecting to 5GC and an eNB, and/or between two eNBs connecting to 5GC (e.g., CN 1424).

The RAN 1406 is shown to be communicatively coupled to the CN 1424. The CN 1424 may comprise one or more network elements 1426, which are configured to offer various data and telecommunications services to customers/subscribers (e.g., users of UE 1402 and UE 1404) who are connected to the CN 1424 via the RAN 1406. The components of the CN 1424 may be implemented in one physical device or separate physical devices including components to read and execute instructions from a machine-readable or computer-readable medium (e.g., a non-transitory machine-readable storage medium).

In embodiments, the CN 1424 may be an EPC, and the RAN 1406 may be connected with the CN 1424 via an S1 interface 1428. In embodiments, the S1 interface 1428 may be split into two parts, an S1 user plane (S1-U) interface, which carries traffic data between the base station 1412 or base station 1414 and a serving gateway (S-GW), and the S1-MME interface, which is a signaling interface between the base station 1412 or base station 1414 and mobility management entities (MMEs).

In embodiments, the CN 1424 may be a 5GC, and the RAN 1406 may be connected with the CN 1424 via an NG interface 1428. In embodiments, the NG interface 1428 may be split into two parts, an NG user plane (NG-U) interface, which carries traffic data between the base station 1412 or base station 1414 and a user plane function (UPF), and the S1 control plane (NG-C) interface, which is a signaling interface between the base station 1412 or base station 1414 and access and mobility management functions (AMFs).

Generally, an application server 1430 may be an element offering applications that use internet protocol (IP) bearer resources with the CN 1424 (e.g., packet switched data services). The application server 1430 can also be configured to support one or more communication services (e.g., VoIP sessions, group communication sessions, etc.) for the UE 1402 and UE 1404 via the CN 1424. The application server 1430 may communicate with the CN 1424 through an IP communications interface 1432.

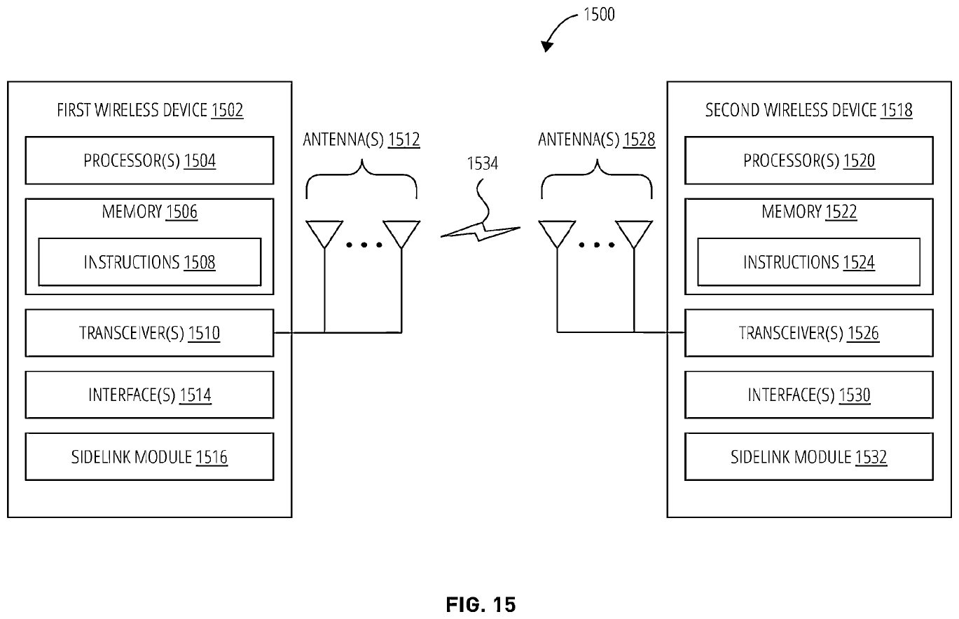

FIG. 15 illustrates a system 1500 for performing signaling 1534 between a first wireless device 1502 and a second wireless device 1518, according to embodiments disclosed herein. The system 1500 may be a portion of a wireless communications system as herein described. The first wireless device 1502 may be, for example, a UE of a wireless communication system. The second wireless device 1518 may be, for example, a UE of the wireless communication system.

The first wireless device 1502 may include one or more processor(s) 1504. The processor(s) 1504 may execute instructions such that various operations of the first wireless device 1502 are performed, as described herein. The processor(s) 1504 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The first wireless device 1502 may include a memory 1506. The memory 1506 may be a non-transitory computer-readable storage medium that stores instructions 1508 (which may include, for example, the instructions being executed by the processor(s) 1504). The instructions 1508 may also be referred to as program code or a computer program. The memory 1506 may also store data used by, and results computed by, the processor(s) 1504.

The first wireless device 1502 may include one or more transceiver(s) 1510 that may include radio frequency (RF) transmitter and/or receiver circuitry that use the antenna(s) 1512 of the first wireless device 1502 to facilitate signaling (e.g., the signaling 1534) to and/or from the first wireless device 1502 with other devices (e.g., the second wireless device 1518) according to corresponding RATs.

The first wireless device 1502 may include one or more antenna(s) 1512 (e.g., one, two, four, or more). For embodiments with multiple antenna(s) 1512, the first wireless device 1502 may leverage the spatial diversity of such multiple antenna(s) 1512 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the first wireless device 1502 may be accomplished according to precoding (or digital beamforming) that is applied at the first wireless device 1502 that multiplexes the data streams across the antenna(s) 1512 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the first wireless device 1502 may implement analog beamforming techniques, whereby phases of the signals sent by the antenna(s) 1512 are relatively adjusted such that the (joint) transmission of the antenna(s) 1512 can be directed (this is sometimes referred to as beam steering).

The first wireless device 1502 may include one or more interface(s) 1514. The interface(s) 1514 may be used to provide input to or output from the first wireless device 1502. For example, a first wireless device 1502 that is a UE may include interface(s) 1514 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 1510/antenna(s) 1512 already described) that allow for communication between the UE and other devices and may operate according to known protocols (e.g., Wi-Fi®, Bluetooth®, and the like).

The first wireless device 1502 may include a sidelink module 1516. The sidelink module 1516 may be implemented via hardware, software, or combinations thereof. For example, the sidelink module 1516 may be implemented as a processor, circuit, and/or instructions 1508 stored in the memory 1506 and executed by the processor(s) 1504. In some examples, the sidelink module 1516 may be integrated within the processor(s) 1504 and/or the transceiver(s) 1510. For example, the sidelink module 1516 may be implemented by a combination of software components (e.g., executed by a DSP or a general processor) and hardware components (e.g., logic gates and circuitry) within the processor(s) 1504 or the transceiver(s) 1510.

The sidelink module 1516 may be used for various aspects of the present disclosure, for example, aspects of FIG. 1 to FIG. 13. For example, the sidelink module 1516 may be configured to perform procedures for triggering SL beam measurement as described herein, perform procedures for SL beam maintenance as described herein, and/or send beam reports having contents as described herein. The sidelink module 1516 may be configured to enact functionalities of one of a Tx UE 102 and/or a Rx UE 104, as described herein.

The second wireless device 1518 may include one or more processor(s) 1520. The processor(s) 1520 may execute instructions such that various operations of the second wireless device 1518 are performed, as described herein. The processor(s) 1520 may include one or more baseband processors implemented using, for example, a CPU, a DSP, an ASIC, a controller, an FPGA device, another hardware device, a firmware device, or any combination thereof configured to perform the operations described herein.

The second wireless device 1518 may include a memory 1522. The memory 1522 may be a non-transitory computer-readable storage medium that stores instructions 1524 (which may include, for example, the instructions being executed by the processor(s) 1520). The instructions 1524 may also be referred to as program code or a computer program. The memory 1522 may also store data used by, and results computed by, the processor(s) 1520.

The second wireless device 1518 may include one or more transceiver(s) 1526 that may include RF transmitter and/or receiver circuitry that use the antenna(s) 1528 of the second wireless device 1518 to facilitate signaling (e.g., the signaling 1534) to and/or from the second wireless device 1518 with other devices (e.g., the first wireless device 1502) according to corresponding RATs.

The second wireless device 1518 may include one or more antenna(s) 1528 (e.g., one, two, four, or more). In embodiments having multiple antenna(s) 1528, the second wireless device 1518 may perform MIMO, digital beamforming, analog beamforming, beam steering, etc., as has been described.

The second wireless device 1518 may include one or more interface(s) 1530. The interface(s) 1530 may be used to provide input to or output from the second wireless device 1518. For example, a second wireless device 1518 that is a UE may include interface(s) 1530 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 1526/antenna(s) 1528 already described) that allow for communication between the UE and other devices and may operate according to known protocols (e.g., Wi-Fi®, Bluetooth™, and the like).

The second wireless device 1518 may include a sidelink module 1532. The sidelink module 1532 may be implemented via hardware, software, or combinations thereof. For example, the sidelink module 1532 may be implemented as a processor, circuit, and/or instructions 1524 stored in the memory 1522 and executed by the processor(s) 1520. In some examples, the sidelink module 1532 may be integrated within the processor(s) 1520 and/or the transceiver(s) 1526. For example, the sidelink module 1532 may be implemented by a combination of software components (e.g., executed by a DSP or a general processor) and hardware components (e.g., logic gates and circuitry) within the processor(s) 1520 or the transceiver(s) 1526.

The sidelink module 1532 may be used for various aspects of the present disclosure, for example, aspects of FIG. 1 through FIG. 13. For example, the sidelink module 1532 may be configured to perform procedures for triggering SL beam measurement as described herein, perform procedures for SL beam maintenance as described herein, and/or send beam reports having contents as described herein. The sidelink module 1532 may be configured to enact functionalities of one of a Tx UE 102 and/or an Rx UE 104 (e.g., opposite of the functionality currently enacted by the sidelink module 1516), as described herein.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1-16. (canceled)

17. A method of a transmit (Tx) user equipment (UE) for performing sidelink (SL) communications with a receive (Rx) UE, comprising:
sending, to the Rx UE, one or more combined physical sidelink control channel (PSCCH)/physical sidelink shared channel (PSSCH) transmissions comprising one or more channel state information reference signals (CSI-RSs) configured to be used at the Rx UE for one or more beam measurements:
receiving, from the Rx UE, one or more beam reports corresponding to the one or more beam measurements, each of the one or more beam reports comprising a measured quality of a serving beam; and
determining whether to perform a beam paring procedure based on a comparison of the measured quality of the serving beam from each of the one or more beam reports to a threshold.

18. The method of claim 17, wherein the beam paring procedure is performed when the measured quality of the serving beam from a minimum number of the one or more beam reports is below the threshold.

19. The method of claim 17, wherein the beam paring procedure is performed with the measured quality of the serving beam from a minimum number of consecutive beam reports of the one or more beam reports is below the threshold.

20. The method of claim 17, wherein the one or more combined PSCCH/PSSCH transmissions are sent in response to an expiration of a SL beam maintenance timer.

21. The method of claim 17, wherein the one or more combined PSCCH/PSSCH transmissions are sent according to a beam measurement periodicity configured at the Tx UE.

22. The method of claim 17, wherein the one or more combined PSCCH/PSSCH transmissions are sent in response to a request received from the Rx UE.

23. The method of claim 17, further comprising detecting a beam measurement event at the Tx UE, and wherein the one or more combined PSCCH/PSSCH transmissions are sent in response to detecting the beam measurement event.

24. The method of claim 17, wherein the one or more combined PSCCH/PSSCH transmissions are sent on resources selected using a SL resource selection procedure.

25. The method of claim 24, wherein a packet delay budget (PDB) for the SL resource selection procedure is based on a configured timer value.

26. The method of claim 24, wherein a priority value for the one or more combined PSCCH/PSSCH transmissions used during the SL resource selection procedure is determined at the Tx UE according to a resource pool used for the one or more combined PSCCH/PSSCH transmissions.

27. The method of claim 24, wherein a priority value for the one or more combined PSCCH/PSSCH transmissions used during the SL resource selection procedure is pre-defined at the Tx UE.

28. The method of claim 24, wherein a priority value for the one or more combined PSCCH/PSSCH transmissions used during the SL resource selection procedure is configured by signaling between the Tx UE and the Rx UE.

29. The method of claim 17, wherein the one or more combined PSCCH/PSSCH transmissions are sent using dedicated resources.

30. The method of claim 29, wherein the dedicated resources are periodically reserved.

31. The method of claim 29, wherein the dedicated resources correspond to sub-channels indicated by a resource pool configuration for a resource pool used for the one or more combined PSCCH/PSSCH transmissions.

32-48. (canceled)

49. A method of a receive (Rx) user equipment (UE) for performing sidelink (SL) communications with a transmit (Tx) UE, comprising:
receiving, from the Tx UE, a combined physical sidelink control channel (PSCCH)/physical sidelink shared channel (PSSCH) transmission comprising one or more channel state information reference signals (CSI-RSs) configured to be used at the Rx UE for a beam measurement:
performing the beam measurement using the one or more CSI-RSs; and
sending, to the Tx UE, a beam report corresponding to the beam measurement, the beam report comprising one or more measured quality fields corresponding to beams of the beam report, the one or more measured quality fields comprising an absolute measured quality value of a first beam of the beam report.

50. The method of claim 49, wherein the one or more measured quality fields further comprise a differential measured quality value of a second beam of the beam report, wherein the differential measured quality value is differential to the absolute measured quality value of the first beam.

51. The method of claim 49, wherein the beam report is sent in a medium access control control element (MAC CE).

52. The method of claim 49, wherein the beam report is sent in sidelink channel information (SCI).

53. The method of claim 49, wherein the one or more measured quality fields are ordered in the beam report according to beam identifiers (IDs) of one or more corresponding beams.

54-69. (canceled)
